(19) United States
(12) Patent Application Publication
(10) Pub. No.: US 2019/0114300 A1
(43) Pub. Date: Apr. 18, 2019

(54) Reading Level Based Text Simplification

(71) Applicant: Choosito! Inc., Wynnewood, PA (US)

(72) Inventor: Eleni Miltsakaki, Wynnewood, PA (US)

(21) Appl. No.: 16/159,515

(22) Filed: Oct. 12, 2018

Related U.S. Application Data
(60) Provisional application No. 62/571,928, filed on Oct. 13, 2017.

(51) Int. Cl. G06F 16/35; G06F 17/27; G06N 5/04

(52) U.S. Cl. CPC G06F 16/35; G06N 5/046; G06F 17/2785

(57) ABSTRACT

A system classifies a reading level of an input text. A user provides 1) an input text having an original reading level, and 2) a selection of a selected target reading level, out of a plurality of target reading levels, through a user interface. A reading level estimation engine is configured to determine the original reading level of the input text. A database is configured to hold data relating to the reading level of a plurality of texts. A text simplification engine is configured to simplify the input text on the basis of the selected target reading level, and to communicate with the database to obtain data relating to a reading level classification of words from the archived texts. Lastly, the text simplification engine is configured to prepare and output a simplified text of a less difficult reading level that substantially preserves the meaning of the input text.

### PRIORITY

This patent application claims priority from provisional U.S. patent application No. 62/571,928, filed Oct. 13, 2017, entitled, “TEXT SIMPLIFICATION,” and naming Eleni Miltsakaki as inventor, the disclosure of which is incorporated herein, in its entirety, by reference.

### FIELD OF THE INVENTION

Various embodiments of the invention generally relate to text simplification and, more particularly, illustrative embodiments of the invention relate to simplifying a text based on a target reading level.

### BACKGROUND OF THE INVENTION

Reading comprehension skills vary based on education, personal development, and foreign language skills of readers. For example, information found on the Internet may not be at an appropriate reading level for young students or for those for whom English is a second language. In many instances, users of the Internet in search of an answer to a question or reading material are faced with results having challenging content and/or elevated grammar.

### SUMMARY OF VARIOUS EMBODIMENTS

In accordance with one embodiment of the invention, a system classifies a reading level of an input text. The system includes an interface configured to receive 1) an input text having an original reading level, and 2) a selection of a selected target reading level for converting the input text. The selection of the target reading level is out of a plurality of target reading levels. The system has a reading level estimation engine that is configured to determine or estimate the original reading level of the input text. The system also has a reading level database configured to hold data relating to the reading level of a plurality of archived texts. Additionally, the system has a text simplification engine. The text simplification engine is configured to simplify the input text on the basis of the selected target reading level. The text simplification engine is further configured to communicate with the reading level database to obtain data relating to a reading level classification of words from the plurality of archived texts. The text simplification engine is trained to simplify text using the training data. Lastly, the text simplification engine is configured to prepare and output a simplified text of a less difficult reading level than the input text that substantially preserves the meaning of the input text.

In some embodiments, the text simplification engine uses the frequency of a particular word and/or phrase that has the target reading level to simplify texts. Accordingly the text simplification engine may substitute words and/or phrases at the original reading level with words and/or phrases having a higher probability of being in the target reading level.

Furthermore, the text simplification engine may be configured to output a plurality of simplified text options. In such a case, the text simplification engine may receive a selection and/or a modification of at least one of the plurality of simplified text options. The text simplification engine may be configured to use the selection and/or the modification as feedback to update the reading level database, so as to improve the quality of future simplified texts.

The system may include a parsing module configured to parse the input text into its grammatical constituents. Furthermore, the system may include a topic modeling module configured to analyze the input text to determine the topic of its content. Additionally, or alternatively, the system may include a sentence splitting module configured to split, delete, and reorganize sentences from the input text in order to simplify the text.

In accordance with yet another embodiment, a computer database system includes an archive of words in texts. Each of the texts is assigned a reading level out of a plurality of reading levels. A plurality of the individual words and/or phrases in a respective text also receives an assigned reading level that corresponds to the respective text. The system is configured to calculate a probability level indicative of a probability that a particular word and/or phrase is in a particular reading level. The probability level is calculated on the basis of the plurality of assigned reading levels of the particular word and/or phrase. The system is further configured to communicate with a convolutional neural network to determine or estimate the reading level of an inputted text on the basis of at least the frequency and probability level of words and/or phrases in the inputted text.

In some embodiments, the system is configured to: 1) output a simplified text option at a target reading level, and 2) to receive feedback on the simplified text option from a user. Additionally, the database is configured to modify the probability level of a word and/or phrase in the simplified text option on the basis of the feedback. In some embodiments, the feedback is a selection and/or modification of the simplified text option

In accordance with yet another embodiment, a computer-implemented method for simplifying an input text receives an input text. The method generates an estimated reading level, from of a plurality of reading levels, for the input text. The method also generates a simplified version of the input text, based on a reading level that is less difficult than the estimated reading level, in a manner that preserves a meaning of the input text in the simplified version. The method also outputs the simplified version to a user interface.

In some embodiments, generating the estimate of the reading level of the input text includes quantifying the difficulty of the input text by using a convolutional neural network. Additionally, or alternatively, generating the estimate may include accessing a database having an assigned word difficulty level for a plurality of texts, where substantially all of the words in each of the texts may be assigned the difficulty level of their respective text. Furthermore, a word difficulty level may be generated based on the frequency that a selected word is assigned a selected reading level. Additionally, the word difficulty level of the words in the input text may be used to generate the estimated reading level of the input text.

Among other ways, the input text may be received from a web-browser and may be output in the web-browser. Although in some embodiments the text may be an entire document, some input texts may include portions of the document.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a user simplifying an input text using a text simplification system in accordance with illustrative embodiments of the invention.

FIG. 2 schematically shows details of the system implementing the text simplification process in accordance with illustrative embodiments of the invention.

FIG. 3 shows a text simplification process in accordance with illustrative embodiments of the invention.

FIG. 4 schematically shows a reading level database of the system in accordance with illustrative embodiments of the invention.

FIG. 5 shows a process for performing text simplification using the text simplification engine in accordance with illustrative embodiments of the invention.

FIG. 6 schematically shows an example of a parse tree in accordance with illustrative embodiments of the invention.

FIG. 7 shows a process performed by the topic modeling module described in accordance with illustrative embodiments.

FIG. 8 shows a process for training the text simplification engine in accordance with illustrative embodiments of the invention

FIG. 9A schematically shows parallel texts in accordance with illustrative embodiments of the invention.

FIG. 9B schematically shows the input text at a first reading level converted to an output text at a second reading level in accordance with illustrative embodiments of the invention.

### DESCRIPTION OF ILLUSTRATIVE EMBODIMENTS

Illustrative embodiments enhance reading comprehension of a text by providing reading-level appropriate text simplification. To that end, the text (e.g., an entire document, chapter, paragraph, sentence, or selection) is input into a system that generates an estimated reading level for the input text. The system simplifies the input text on the basis of a selected target reading level. More specifically, the text is converted to the target reading level by swapping words and/or phrases that have a high probability of being in the target reading level. Furthermore, grammatical changes and or sentence splicing may also be used to simplify the document. Details of illustrative embodiments are discussed below.

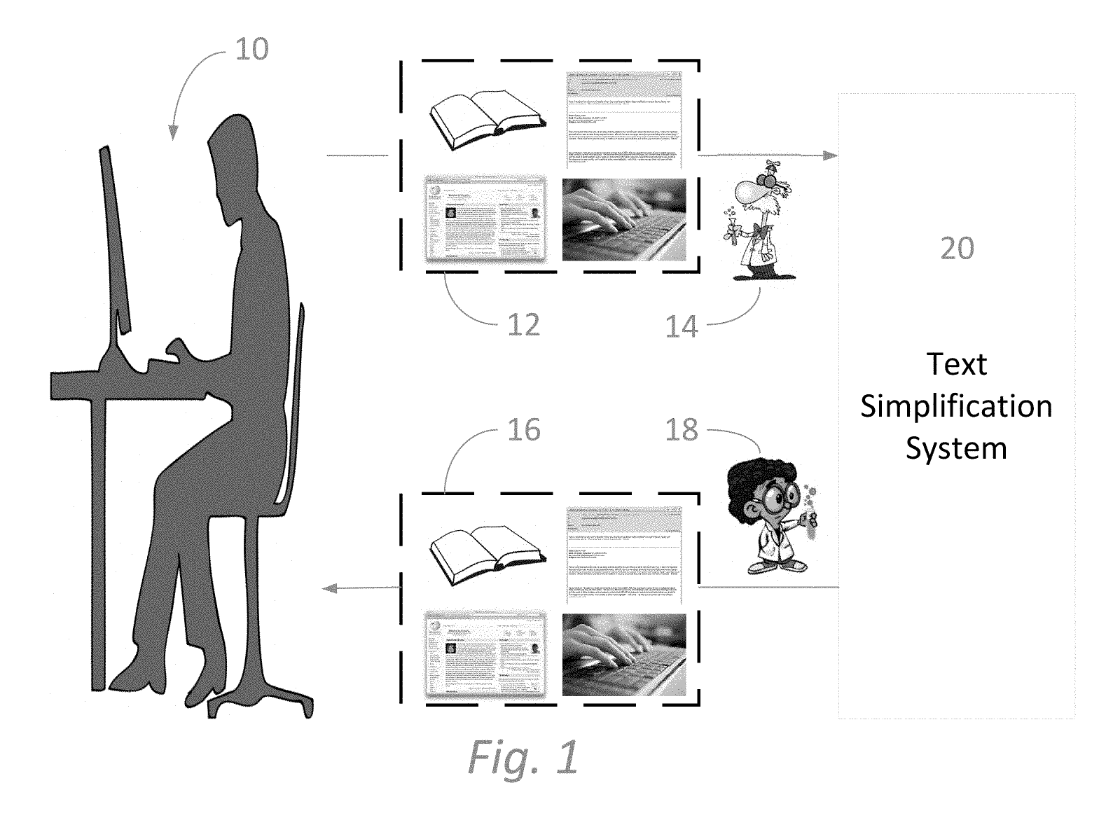

FIG. 1 schematically shows a user 10 simplifying an input text 12 using a text simplification system 20 in accordance with illustrative embodiments of the invention. The user 10, who may be, for example, a young student, a challenged reader, or a non-native English speaker, may wish to better comprehend the particular text 12. Accordingly, the user 10 inputs the input text 12 into the text simplification system 20, the text simplification system 20 simplifies the text 12 while preserving its meaning, and the system 20 outputs a simplified text 16 to the user 10. The input text 12 may be from any of a wide variety of sources having text, such as a book, an article, an email, a website, or manually entered (e.g., typed). Furthermore, the user 10 may select the entirety of the text 12 or only a portion thereof (e.g., a chapter, a passage, a paragraph, a sentence, etc.). However, it should be understood that the examples of input text 12 are not intended to limit illustrative embodiments of the invention.

The input text 12 is considered to have a comprehension reading level (referred to herein as original reading level 14). As shown in FIG. 1, the original reading level 14 may be relatively high, e.g., it may be intended for a well-educated audience (e.g., represented by the adult scientist reading level 14). However, the user 10 may wish to have the input text 12 in a form that is comprehensible at a lower target reading level 18 (represented by the young scientist reading level 18). Accordingly, the user 10 selects the appropriate target reading level 18 for the text 12, and the text simplification system 20 outputs the simplified text 16. As a non-limited example, the user 10 may be a grade school teacher that is simplifying a complex article 12 written at a college-student reading level 14 for her fifth-grade class target reading level 18.

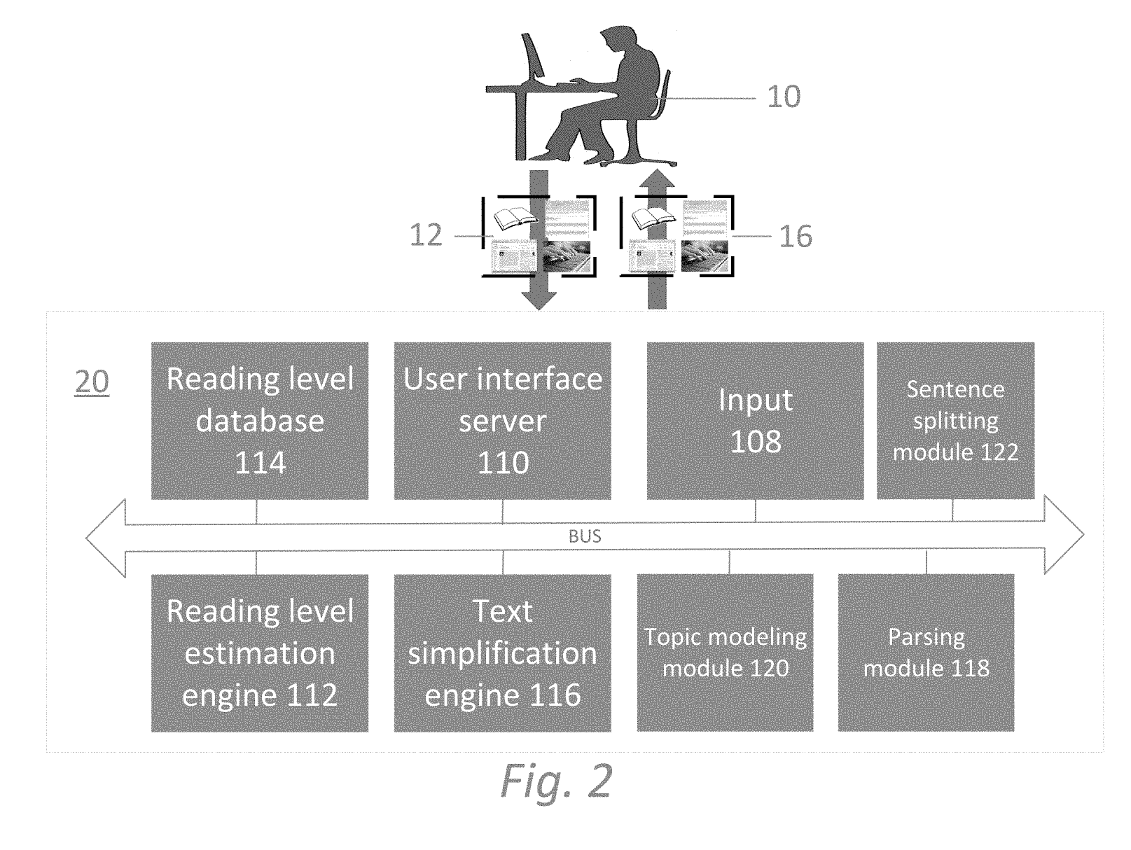

While the above example describes a teacher using the system 20, it should be understood that young students, challenged readers, non-native English speakers and/or others may also be users 10 of the system 20. In fact, various embodiments can be used in a variety of different languages and thus, discussion of English simplification is but one example. Furthermore, some embodiments may not have a human user 10. For example, a machine learning and/or a neural network may be trained to use the system 20 (e.g., to update a reading level database, and/or improve a reading estimation level engine and/or a text simplification engine—discussed with reference to FIG. 2).

FIG. 2 schematically shows details of the system 20 implementing the text simplification process in accordance with illustrative embodiments of the invention. As shown in FIG. 2, the system 20 has an input 108 configured to receive the input text 12, e.g., the scientific article written for the adult scientist reading level 14. Additionally, in some embodiments, the input 108 is configured to receive a selection of the target reading level 18, e.g., the fifth grade target reading level 18. It should be understood that while the term “text” is used, illustrative embodiments are not limited to receiving the entirety of the text 12, nor a text file format. Indeed, as described previously, the system 20 may receive portions of the text 12. In some other embodiments, the system 20 may be configured to receive pictures of the text 12, perform word recognition on the picture, and analyze the text 12 recognized in the picture. Thus, “text” is considered to include any selection of words and/or phrases that are grammatically linked together and could benefit from simplification to enhance reading comprehension.

The system 20 has a user interface server 110 configured to provide a user interface through which the user may communicate with the system 20. The user 10 may access the user interface via an electronic device (such as a computer, smartphone, etc.), and use the electronic device to provide the input text 12 to the input 108. In some embodiments, the electronic device may be a networked device, such as an Internet-connected smartphone or desktop computer. The user input text 12 may be, for example, a sentence typed manually by the user 10. To that end, the user device may have an integrated keyboard (e.g., connected by USB). Alternatively, the user may upload, or provided a link to, an already written text 12 (e.g., Microsoft Word file, Wikipedia article) that contains the user 10 inputted text 12.

The input 108 is also configured to receive the target reading level 18. To that end, the user interface server 110 may display a number of selectable target reading level 18 options to the user 10. In some embodiments, the system 20 analyzes the input text 12, determines the original reading level 14, and offers selection of target reading level 18 that are less difficult than the original reading level 14. Additionally, or alternatively, the system 20 may select a pre-determined reading level 18 for the user 10 (e.g., based on a pre-defined user 10 selection, based on previous user 10 preferences, and/or on a questionnaire provided to determine the appropriate reading level of the user 10). In some embodiments, however, the system 20 provides all available reading levels 18 as selectable options.

The system 20 additionally has a reading level database 114 that contains information relating, directly or indirectly, to the reading level of a number of texts whose reading level is predetermined. The system 20 also has a reading level estimation engine 112 that communicates with the reading level database 114 to generate an estimation of the original reading level 14 based on probability that the input text 12 is in a particular reading level. Additionally, or alternatively, the reading level database 114 may make a definitive determination that the input text 12 is at a particular reading level.

Each of the above-described components in FIG. 2 is operatively connected by any conventional interconnect mechanism. FIG. 2 simply shows a bus communicating each of the components. Those skilled in the art should understand that this generalized representation can be modified to include other conventional direct or indirect connections. Accordingly, discussion of a bus is not intended to limit various embodiments.

Indeed, it should be noted that FIG. 2 only schematically shows each of these components. Those skilled in the art should understand that each of these components can be implemented in a variety of conventional manners, such as by using hardware, software, or a combination of hardware and software, across one or more other functional components. For example, the reading level estimation engine 112 may be implemented using a plurality of microprocessors executing firmware. As another example, the text simplification engine 116 may be implemented using one or more application specific integrated circuits (i.e., “ASICs”) and related software, or a combination of ASICs, discrete electronic components (e.g., transistors), and microprocessors. Accordingly, the representation of the text simplification engine 116 and other components in a single box of FIG. 2 is for simplicity purposes only. In fact, in some embodiments, the text simplification engine 116 of FIG. 2 is distributed across a plurality of different machines—not necessarily within the same housing or chassis. Additionally, in some embodiments, components shown as separate (such as the parsing module 118 and the topic modeling module 120 in FIG. 2) may be replaced by a single component. Furthermore, certain components and sub-components in FIG. 2 are optional. For example, some embodiments may not use the sentence splitting module 122.

It should be reiterated that the representation of FIG. 2 is a significantly simplified representation of an actual text simplification system 20. Those skilled in the art should understand that such a device may have other physical and functional components, such as central processing units, other packet processing modules, and short-term memory. Accordingly, this discussion is not intended to suggest that FIG. 2 represents all of the elements of the text system 20.

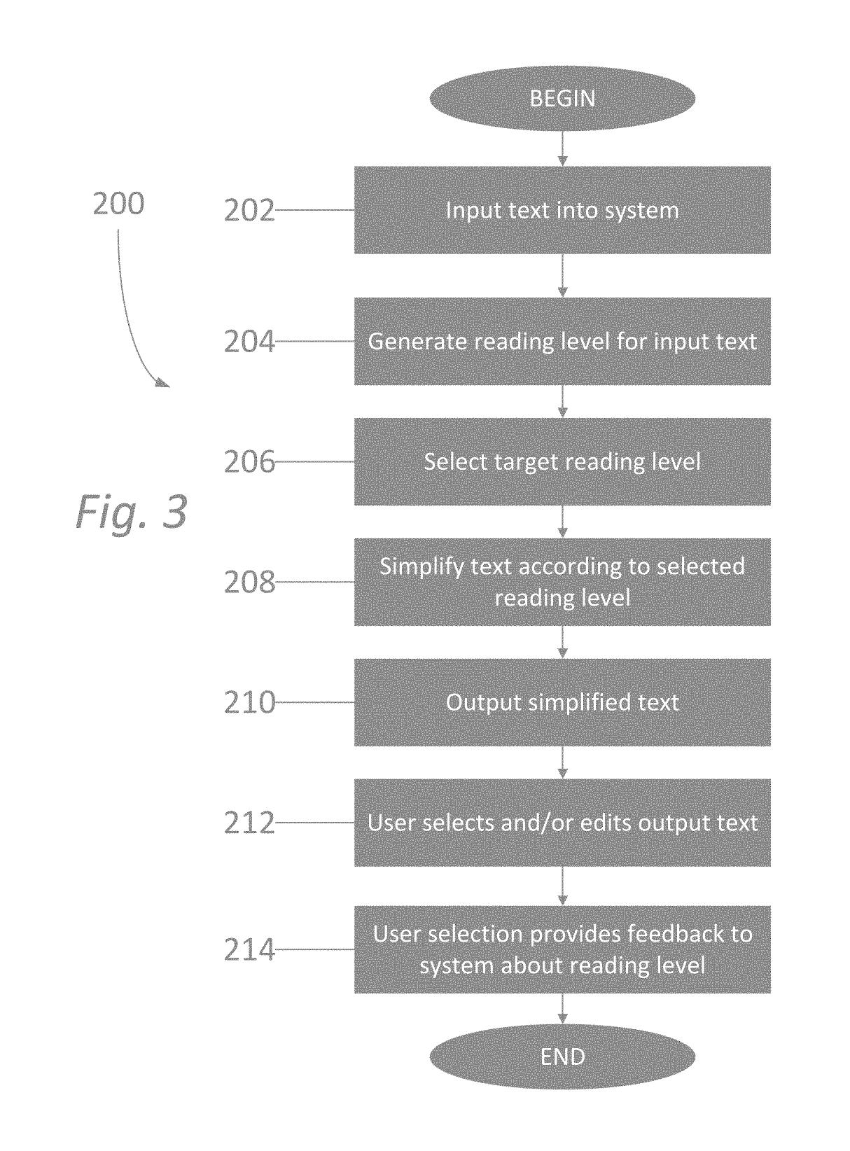

FIG. 3 schematically shows a text simplification process 200 in accordance with illustrative embodiments of the invention. It should be noted that this process is substantially simplified from a longer process that normally would be used to simplify text 12. Accordingly, the process 200 of simplifying text 12 has many steps which those skilled in the art likely would use. In addition, some of the steps may be performed in a different order than that shown, or at the same time. Those skilled in the art therefore can modify the process as appropriate.

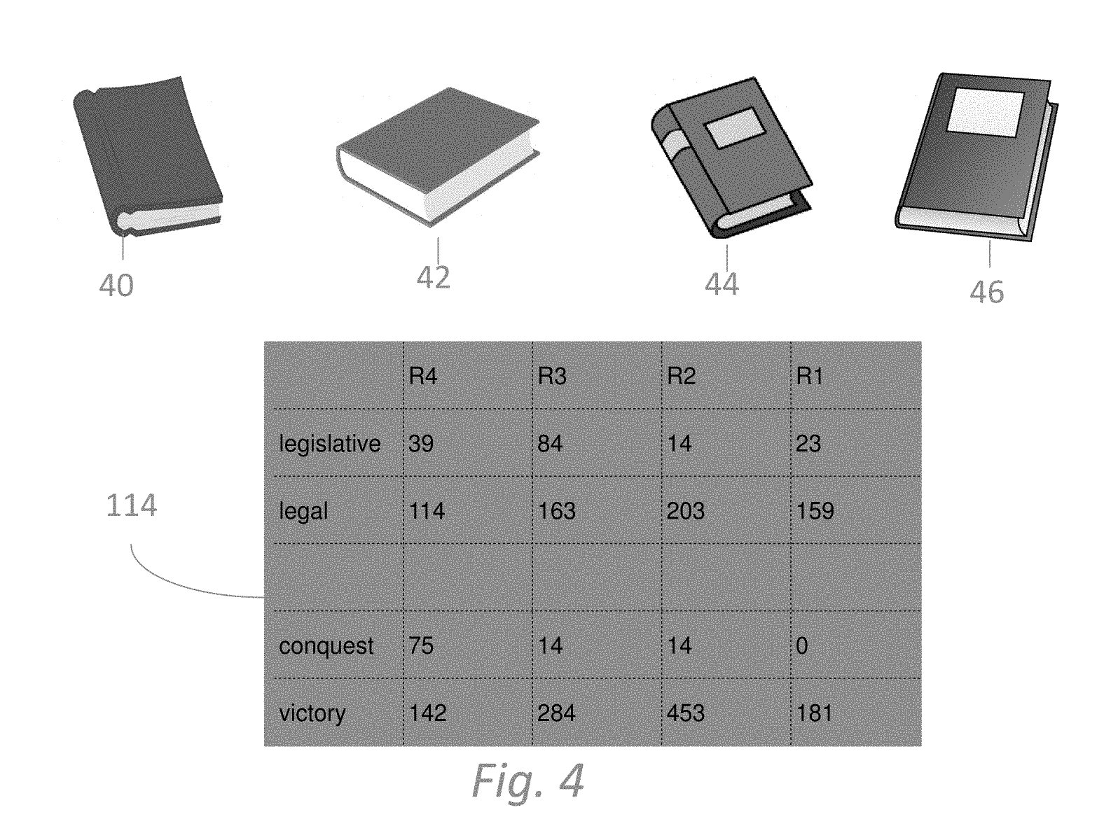

The process of FIG. 3 begins at step 202, where text 12 is inputted into the system 20. The next step in the process 200 is for the system 20 to generate an estimation of the original reading level 14 for the input text 12 (for discussion purposes the estimation of the original reading level 14 is referred to simply as the reading level 14). To generate the reading level 14, a reading level estimation engine 112 communicates with a reading level database 114, as shown in FIG. 2. Additional details are discussed below with reference to FIG. 4.

The process proceeds to step 206 where a target reading level 18 is selected. Although this step is shown as coming after step 204, in some embodiments, the step may be performed at the same time as step 302. However, it may be beneficial for the user 10 to get a determination of the reading level 14 of the inputted text 12 before making the target reading level 18 selection.

The user 10 may select the target reading level 18 using the user interface 110. As discussed previously, the user 10 may be select from a variety of reading levels (e.g., R1-R4) based on the reading level classification style used by the system 20. Additionally, or alternatively, an automatic reading level may be selected on the system 20 (e.g., based on user 10 profile). The target reading level 18 selection is provided to a text simplification engine 116. The text simplification engine 116 receives the inputted text 12 and the target reading level 18.

In some embodiments, the system 20 may receive the input before step 204, and in some other embodiments, after step 204. The system 20 may offer target reading levels 18 on the basis of standard K-12 grade level (i.e., each grade is a different level). In some other embodiments, the system 20 may offer target reading levels 18 that correspond to a cluster of grade levels (e.g., Reading Level 1 correspond to grades 1-3, Reading Level 2 corresponds to grades 4-6). However, a variety of reading levels may be offered by the system 2. It should be understood that illustrative embodiments train the system 20 for each reading level.

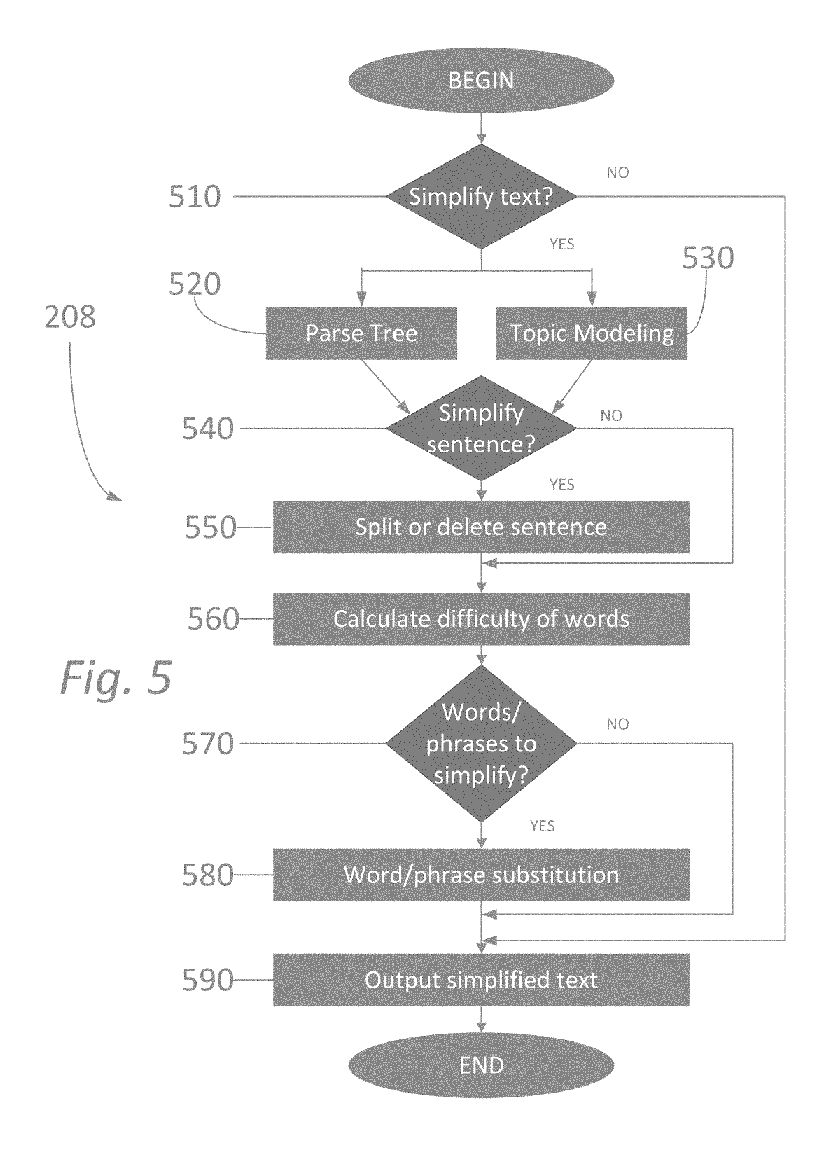

In step 208, the text simplification engine 116 simplifies the text 12 in accordance with the selected target reading level 18. The text simplification engine 116 outputs the simplified text 16. Details of the text simplification engine 116 of illustrative embodiments is discussed below with reference to FIG. 5. The process then moves to step 210, where the simplified text 16 is output to the user 10. In some embodiments, the process 200 ends here. However, optionally, a plurality of simplified text 16 options may be output to the user 10.

The process then moves to step 212, where the user evaluates and accepts, rejects, or modifies the simplified text 16 suggestions. The process then moves to step 214, where the user's 10 actions at step 212 provide a feedback loop to improve the quality of future simplified text 16 provided by the text simplification engine 116. The process 200 then comes to an end.

FIG. 4 schematically shows the reading level database 114 that is accessed by the reading level estimation engine 112 in accordance with illustrative embodiments of the invention. The reading level database 114 contains information relating, directly or indirectly, to the reading level of a number of texts 40-46 whose reading level is predetermined. For simplification purposes, only four texts 40-46 are shown in this particular example, however, it should be understood that illustrative embodiments may use many more texts than the four shown.

In illustrative embodiments, text 40, text 42, text 44, and text 46 are assigned a particular reading level R1-R4. For example, R1 may correspond to reading levels for grades 1-3, R2 may correspond to reading levels for grades 4-6, R3 may correspond to reading levels for grades 7-9, and R4 may correspond to reading levels for grades 10-12. Initially, the classification may be performed manually, for example, by an administrator. However, in some embodiments, readability formulas (e.g., Flesch-Kincaid, Lix, etc.) may be used to assign reading levels to particular texts 40-46.

In some embodiments, machine learning (e.g., the reading level estimation engine 112 and/or the text simplification engine 116) accesses data relating to particular words (e.g., their frequency of use at particular reading levels R1-R4) and their corresponding reading level R1-R4 in the database 114. The machine learning algorithm may use, for example, Bayesian logic or a fast distributed algorithm for mining to determine the reading levels R1-R4 of the input text 12. Furthermore, the machine learning algorithm may be trained using data collected automatically from crawled web-pages. Clean text 12 may be extracted from the web-pages and used to compute language and readability features. A linear regression prediction model may be used to predict the readability levels using, for example, the open-source Java implementation LIBLINEAR. Other machine learning algorithms that may be used include: SVM, MAXENT, and/or REINFORCEMENT LEARNING.

Additionally, or alternatively, some embodiments may use a neural network. As known by those of skill in the art, the neural network determines its own set of rules for performing the desired function (i.e., classifying reading levels) that are outside the scope of this application. However, some embodiments may include the logical processes described below.

In the example shown in FIG. 4, after analyzing the texts 40-46, the administrator determines that: the text 40 is written for the most advanced reading level R4, text 42 is written for the second highest reading level R3, text 44 is written for yet a lower reading level R2, and text 46 is written for the lowest reading level R1. The words in each text 40-46 correspond to a certain reading level R1-R4 (i.e., in this example the reading level of the respective text 40-46), and this data is used to perform subsequent classifications. It should be understood that multiple reading levels R1-R4 may have the same words. Meaning, the word “legislative” may be present at all reading levels R1-R4, but may have a higher prevalence in one particular reading level. Additionally, the combination of a particular word with other nearby words may affect the likelihood of the word falling into a particular reading level R1-R4. Neural networks capture these relationships between words that can be used to estimate the reading difficulty of the input text 12.

Each of these archived texts 40-46 contain a number of words and phrases that may be unique to the particular text 40-46, and a number of words and phrases that are shared throughout the texts 40-46. Shared words may include, for example, “legislative” and “legal.” In the example database 114 shown, text 40 has 39 uses of “legislative” and 114 uses of “legal”; text 42 has 84 uses of “legislative” and 163 uses of “legal”; text 44 has 14 uses of “legislative” and 203 uses of “legal”; text 46 has 23 uses of “legislative” and 159 uses of “legal.” It should be understood that in this simple example, each reading level R1-R4 has a single text 40-46. Generally, a corpus of texts for each reading level are used. However, based on this limited sample size of four texts 40-46, the reading level estimation engine 112 knows that the word “legislative” is highly correlated with an R3 and R4 reading level. Furthermore, the reading level estimation engine 112 knows that the prevalence of the word “legal” is highly correlated with an R2 reading level, especially when the word “legislative” is not as present. This process can be repeated for other words, such as “conquest” and “victory. Accordingly, the database 114 contains data relating to a reading level classification of words (e.g., “legal,” “legislative,” etc.) from the plurality of archived texts 40-46.

The reading level estimation engine 112 thus can use the database 114 to help classify the reading level R1-R4 of newly inputted texts 12 based on the content of the text 12. As a simplified example, if the input text 12 contains a high prevalence of the words “victory” and “legal,” and a low prevalence of the words “legislative” and “conquest,” the reading level estimation engine 112 may determine that the text 12 has a high probability of being in the R2 reading level. Accordingly, the system 20 could assign the R2 reading level to the inputted text 12. At this point, the reading level estimation engine 112 has generated an estimated reading level for the input text 12.

Furthermore, the assignment of this reading level R2 to the inputted text 12 can be used in a feedback loop to further enhance the database 114. For example, if the inputted text 12 contained the word “meritorious,” but none of the other texts 40-46 contained that word, the system 20 (e.g., reading level estimation engine 112) can update the database 114 to reflect that texts with the word “meritorious” have a higher probability of being in the R2 reading level. Accordingly, the reading level estimation engine 112 can update the database 114 and expand the data set to include words outside of the original data set.

A person of skill in the art understands that the example shown and described with reference to FIG. 4 is very simplified. In practice, the robustness of the system 20 is dependent upon the accurate classification of reading levels R1-R4 of a large number of texts 40-46. Thus, the more texts 40-46 that are classified for a particular reading level in the database 114, the more accurate the reading level estimation engine 112 becomes. Furthermore, the neural network may further refine the results of the reading level estimation engine 112 (e.g., as the reading level estimation engine 112 generates reading levels for more texts 12).

While the example discussed above contemplates the usage of words in isolation, it should be understood that this simplified example was merely for discussion purposes. The system 20 may take into account more complex decisions. For example, particular phrases (e.g., “sua sponte”), adjacent and nearby word combinations (e.g., “meritorious victory”), sentence complexity, part of speech, context, syntax, grammar, and lemmatization of words may also factor into the reading level comprehension analysis. Illustrative embodiments are not intended to be limited to the classification of reading level R1-R4 on the basis of isolated word frequency, which was described above merely for ease of explanation.

Furthermore, although the example in FIG. 4 references the reading level R1-R4 classification as taking place on the entire document, it is possible to classify any portion of the text 12. For example, an entire article and/or book may receive a single reading level R1-R4 classification. However, in some embodiments, a chapter, a paragraph, a sentence, or any other portion of the input text 12 may receive a reading level classification. Accordingly, illustrative embodiments may generate an estimated reading level “for” the input text 12 (e.g., any portion thereof), without necessarily requiring that the entire written work receive a single reading level.

FIG. 5 shows a process for performing text simplification using the text simplification engine 116 in accordance with illustrative embodiments of the invention. At step 510, the text simplification engine 116 makes a decision as to whether the input text 12 needs to be simplified. For example, if the reading level 14 of the input text 12 is at a lower reading level than the selected target level 18, no text simplification takes place. One or more considerations can be taken into account such as the number of words, grammatical structure, the topic of discussion, etc. In a preferred embodiment, the text simplification engine 116 includes a Deep Neural Network. If the text 12 does not need to be simplified, the control passes to final stage 590. If the text 12 needs to be simplified, however, control passes to steps 520 and 530, described further below. In some embodiments, steps 520 and 530 are parallelized or serialized steps.

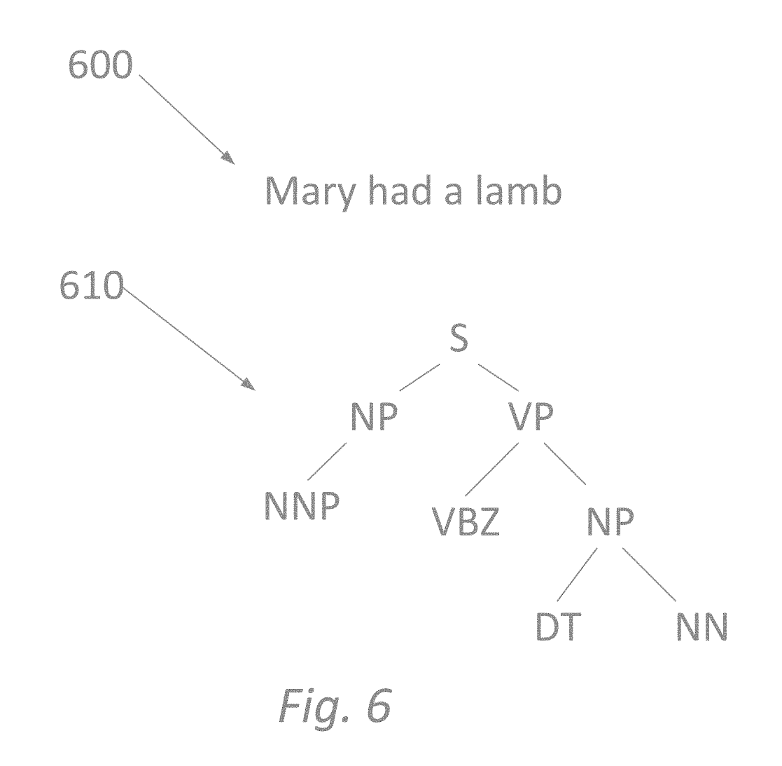

At step 520, a parsing module 118 (FIG. 2) parses the text 12 into its grammatical constituents. In some embodiments, the parsing module 118 is a separate module from the simplification engine 116, and feeds data to the simplification engine 116. In other embodiments, the parsing module 118 may be integrated into the simplification engine 116. In a preferred embodiment, the parsing module 118 constructs a complete parse tree, obtains the grammatical rules, and calculates the depth and breadth of the tree. FIG. 6 schematically shows a diagram illustrating an example of the parse tree 610 described in step 520 of FIG. 5. In some embodiments, this process accepts the input sentence and returns the grammatical constituents of the sentence in the form of the parse tree 610. The diagram shows an example sentence 600 and it is understood that the module may accept a different and arbitrarily long sentence. The process can also compute the depth and breadth of the tree 610. In some embodiments, information relating to the output of the parsing module is fed to the text simplification engine 116 (e.g., machine learning).

At step 530, a topic modeling module 120 of the text simplification engine 116 analyzes the text 12 to determine its content through topic modeling. In a preferred embodiment, the topic modeling is performed through an unsupervised machine learning technique, such as Latent Dirichlet Allocation. In another embodiment, this function may be performed though an unsupervised deep learning technique, such as a Deep Belief Net. In some embodiments, the topic modeling module 120 is a separate module from the simplification engine 116, and feeds data to the simplification engine 116. In other embodiments, the topic modeling module 120 may be integrated into the simplification engine 116.

Returning to the process of FIG. 5, at step 540, the topic modeling module 120 collects the dominant topics and returns them to the user 10, along with the various corresponding probabilities. A sentence splitting module 122 of the text simplification engine 116 combines data output by steps 520 and 530, and makes a determination as to whether any of the sentences in the input text 12 should be split into simpler sentences. At this step, the simplification engine 116 may also determine if certain words in the input text 12 can be deleted without affecting the meaning of the sentence. If the sentence cannot be split, control passes to step 560. Otherwise, control passes to step 550.

Illustrative embodiments may include may other steps that extract information that is useful to the text simplification engine 116. These

At step 550, the sentence splitting module 122 splits the determined sentences of the input text 12 into two or more smaller sentences using input from the parse tree process 520 as well as the topic modeling process 530. Some words from the input text 12 may be discarded at this stage. In some embodiments, the sentence splitting module 122 encodes the relationship between complex and simple sentences. For example, the module 122 learns how to map complex and simple sentences, analyzes an input text 12, and it decodes the information from the input text 12 and generates a simplified sentence if necessary.

At step 560, the reading level estimation engine 112 computes the difficulty of different words in the input text 12. In a preferred embodiment, as described above with references to step 204 of FIG. 3, this procedure is performed by analyzing a large corpus of text 12. In illustrative embodiments, each document in the corpus is categorized by theme and reading level. Each word in the input text 12 is analyzed to compute the frequency of occurrence, which is then used to estimate the difficulty of the words and/or sentences.

At step 570, the simplification engine 116 examines the words in the input text 12 makes a decision as to whether the words may be replaced by simpler alternatives. If the decision is “No” or not to replace existing words with simpler alternatives, the control passes to step 590. Otherwise, the control passes to process 580.

At step 580, the simplification engine 116 replaces the identified difficult words with simpler alternatives. In a preferred embodiment, the simplification engine 116 uses a paraphrase dictionary such as the “Simple paraphrase database for simplification” (also referred to as “simple PPDB”, see http://www.seas.upenn. edu/~nlp/resources/simple-ppdb.tgz). Additionally, the simplification engine 116 may ensure that the output text 16 is grammatically correct.

Additionally, or alternatively, the text simplification engine 116 obtains data relating to a reading level classification of words from the plurality of archived texts 40-46 in the database 115. For example, in FIG. 4, the text simplification engine 116 may wish to replace the word “legislative,” which is a reading level R3 word, with an R2 word. The paraphrase dictionary may indicate that the work “legal” is a suitable substitution, among many other options. By looking at the database 114, the simplification engine 116 can determine that the word “legal” has a high probability of being in the R2 reading level, and may choose to make that substitution. Accordingly, the data relating to the reading level classification of the word “legal,” obtained from the plurality of archived texts 40-46 in the database 114, is used to assist with the text simplification.

At step 590, the simplified sentence is produced and is presented to the user 10. The process then comes to an end.

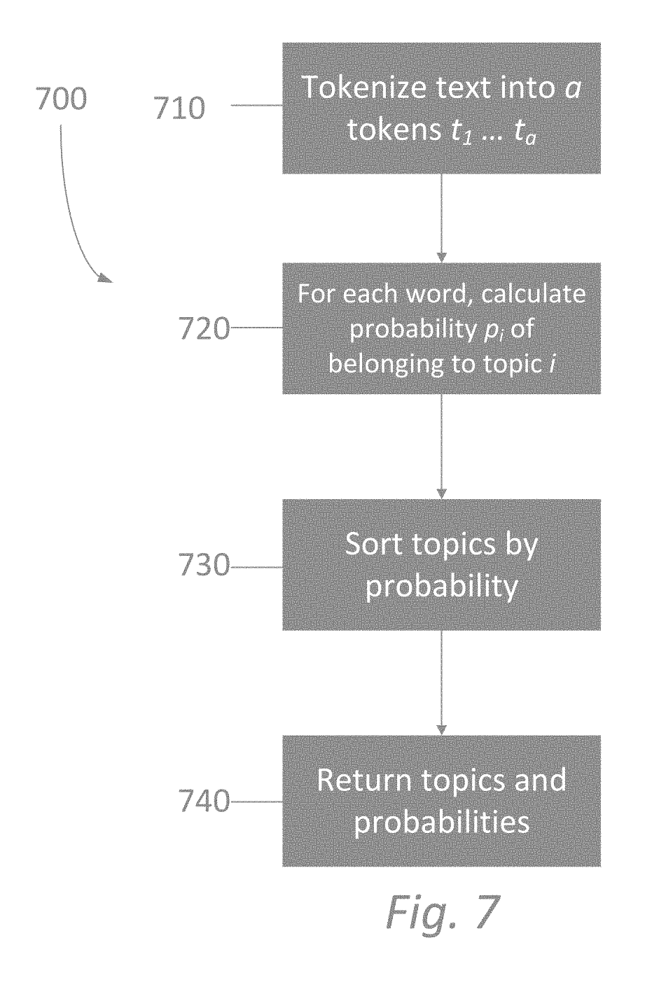

FIG. 7 shows a process 700 performed by the topic modeling module 120 described in step 530 of FIG. 5 in accordance with illustrative embodiments. The first step 710 takes the input sentence and constructs tokens. As before, tokens may include both words and punctuation. In an embodiment, the sentence is broken down into ‘a’ number of tokens t1 . . . to which are fed to the next step 720. One of the advantages of topic modeling is that it can achieve a better understanding of what the sentence means. It is often the case that a given word means different things depending on the context and a robust topic modeling algorithm can help in disambiguation.

At step 720, the topic modeling module 120 computes the probability pi of a particular token belonging to topic i. The module 120 also calculates ‘t’ number of topics, which may be performed in a number of ways. In a preferred embodiment, topic extraction is performed through an unsupervised machine learning technique such as a Latent Dirichlet Allocation (LDA) model trained on our data corpus. In this embodiment, ‘t’ number of latent features, or topics, are identified based on the correlation between words and documents. In a different embodiment, topic extraction may be performed by means of an unsupervised deep learning model such as a Deep Belief Net. Using the trained model, the modeling module 120 analyzes each token to determine the probabilities of various topics represented by each word. Consider the following example that illustrates the importance of disambiguation: the word “Jupiter” may show a high probability of belonging to the topic “Astronomy”, but it may also show a high probability of belonging to the topic “Mythology”, or perhaps even to the topic “Cities and geography”. It is understood that the topics mentioned here are merely examples and other embodiments may include other topics.

At step 730, the topic modeling module 120 sorts the various probabilities to discover the dominant topics. In most cases, only a few dominant topics are required to obtain an understanding of the sentence. In a preferred embodiment, ‘m’ is the maximum probability of a certain word, i.e., the probability of that word belonging to the dominant topic. The process then collects topics with probabilities exceeding b×m, where ‘b’ is a value between 0.0 and 1.0.

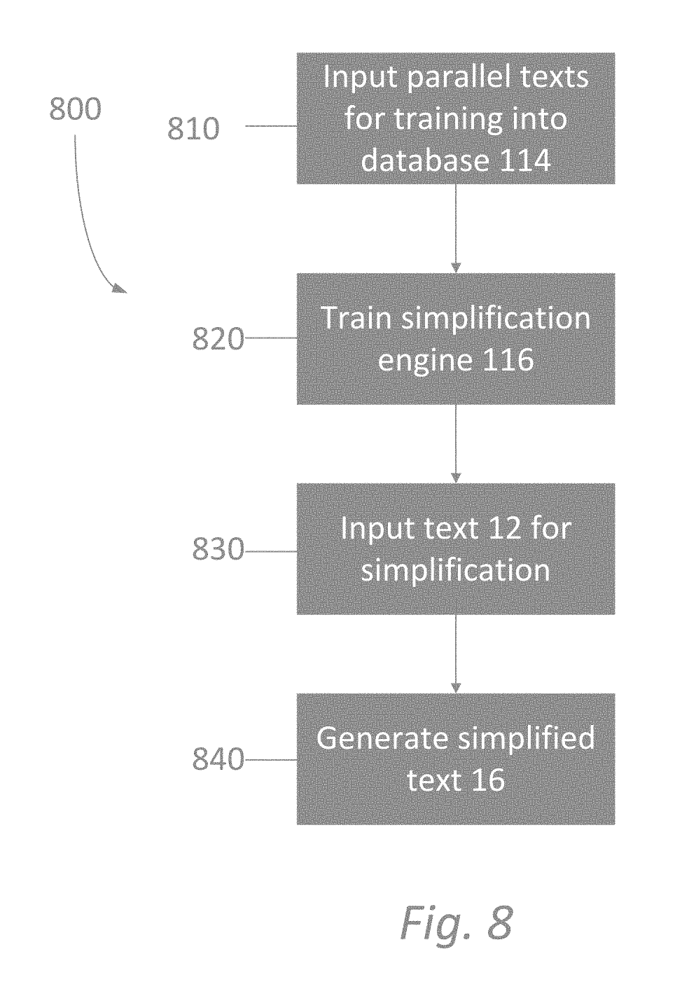

FIG. 8 shows a process 800 for training the text simplification engine 116 in accordance with illustrative embodiments of the invention. The process shown in FIG. 8 provides more detail on step 208 of FIG. 3, which simplifies text according to selected reading level. The process 800 may be used in addition to, or instead of, any of the steps or the entirety of the process 208 shown in step 5.

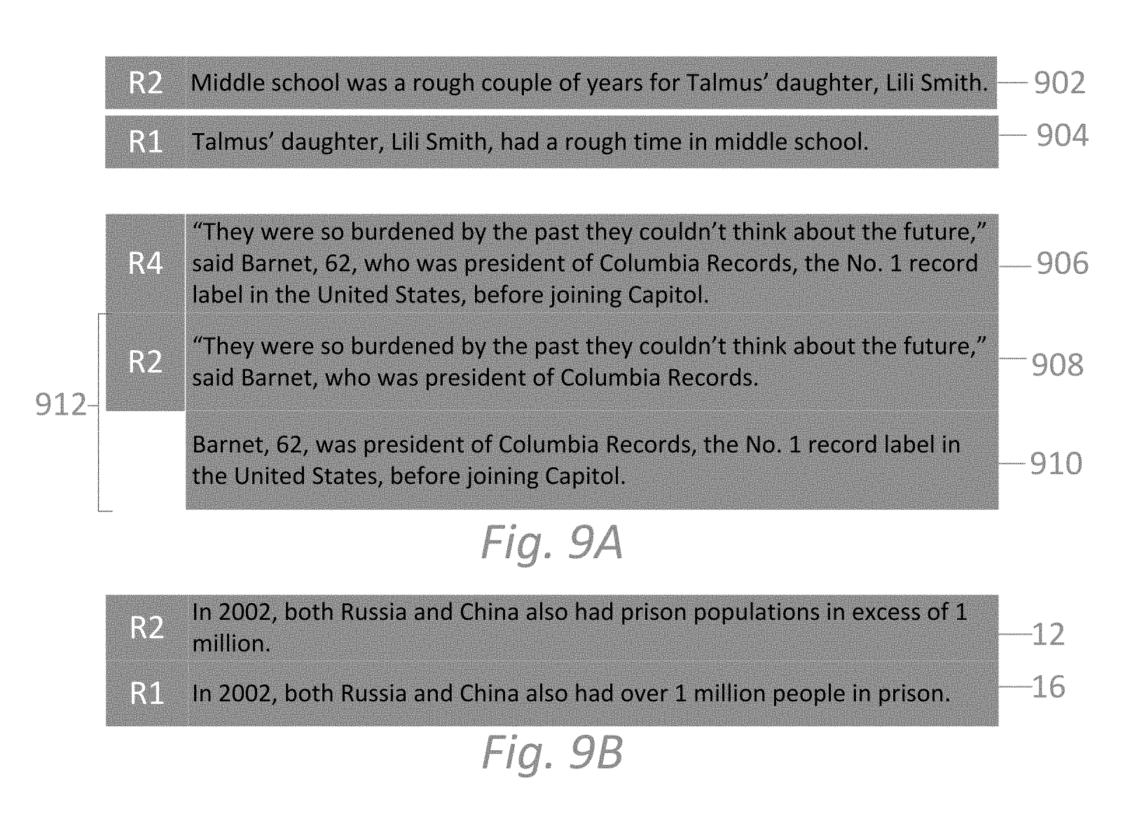

The process 800 begins at step 810, where parallel texts are input into the database 114. Parallel texts are two or more different texts 40-46 that have substantially the same meaning, but are at different reading levels. By accessing a large corpus of parallel texts, the simplification engine 116 trains to detect various reading levels at step 820. For example, the simplification engine 116 may develop a sentence simplification model by encoding the relationship between complex and simple sentences, examples of which are shown in FIG. 9.

FIG. 9A schematically shows parallel texts 902-912 in accordance with illustrative embodiments of the invention. Specifically, two sets of parallel texts are shown: set 1: 902 and 904, and set 2: 906 and 908. Each of the sets are provided to train the simplification engine 116 as to what text is at what reading level. For example, the first parallel text 902 may be provided at reading level R2, and the second parallel text 904 may be provided at reading level R1. Each of these texts 902 and 904 is assigned their respective reading level in the database 114. This process may be repeated for a plurality of texts, although only two sets of parallel texts 902-904 and 906-908 are shown. Each of these parallel texts 902, 904, 906 and 908 may also be referred to as the archived texts described with reference to FIG. 4. Additionally, both of these sets of parallel texts 902-904 and 906-908 have substantially the same meaning. The system 20, after looking at a corpus of parallel texts 902-908, draws conclusions about certain words, syntax, grammatical style, sentence length, and other variables that help define particular reading levels R1-R4.

Optionally, the sentence splitting module 120 may be trained in a similar manner on sets of parallel texts. For example, text 910 may be appended to text 908, and presented as a single unified text 912 that is parallel to text 906. In such a manner, after analyzing a corpus of parallel texts, the sentence splitting module 120 learns when it is appropriate to split a sentence.

While the words here are shown in sentence format, in some embodiments, the system 20 may be trained using vectors. To that end, illustrative embodiments may have a word embedding module, such as word2vec or word2vecf, that models words and/or phrases by mapping them to vectors. The system 20 thus may be trained on vectors in the database 114. Accordingly, in some embodiments, the database 114 may be a vector space. Preferred embodiments use the word2vecf embedding module, which also includes syntactic information about the words and/or phrases in the vectors.

Returning to FIG. 8, at step 820, the text 12 to be simplified is input into the system 20, and the reading level R1-R4 is identified using processes previously described. For example, as shown in FIG. 9B, the input text 12 is classified by the system 20 as being at reading level R2. The process 800 then concludes at step 840, where the input text 12 is simplified and output as simplified text 16. If the user 10 selects to convert the input text 12 to reading level R1, the output may look something similar to the output text 16. During this last step 840, the simplification engine 116 decodes the relationship between a complex input text 12 and the simplified text 16. The process 800 is now complete and the text is simplified.

A person of skill in the art understands that the example shown and described with reference to FIGS. 9A-9B are simplified for discussion purposes. In illustrative embodiments, the system 20 operates when it is trained on a large corpus of text, rather than a single sentence. As described previously, the robustness of the system 20 is dependent upon the accurate classification of reading levels R1-R4 of a large number of texts 40-46. Thus, the more texts 902-908 that are provided to the system 20 and classified for a particular reading level in the database 114, the more accurately trained the reading level estimation engine 112 and the text simplification engine 116 become. Furthermore, the neural network may further refine the results of the reading level estimation engine 112 (e.g., as the reading level estimation engine 112 generates reading levels for more texts 12).

While the example discussed above contemplates the usage of sentences in isolation, it should be understood that this simplified example was merely for discussion purposes. The system 20 may take into account more complex texts, and more than a single word. For example, particular phrases (e.g., “sua sponte”), adjacent and nearby word combinations (e.g., “meritorious victory”), sentence complexity, part of speech, context, syntax, grammar, and lemmatization of words may also factor into the reading level comprehension analysis. Illustrative embodiments are not intended to be limited to the classification of reading level R1-R4 on the basis of isolated word frequency, which was described above merely for ease of explanation.

Furthermore, it should be understood that illustrative embodiments classify various portions of the text 12. For example, some embodiments may classify the reading level of a text based on the content of the entire article and/or book. However, in some embodiments, a chapter, a paragraph, a sentence, or any other portion of the input text 12 may receive a reading level classification. Accordingly, illustrative embodiments may generate an estimated reading level “for” the input text 12 (e.g., any portion thereof), without necessarily requiring that the entire written work receive a single reading level.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims.

A person of skill in the art understands that illustrative embodiments include a number of innovations, including:
1. A computer program product for use on a computer system for simplifying text, the computer program product comprising a tangible, non-transient computer usable medium having computer readable program code thereon, the computer readable program code comprising:
   program code for providing a user interface through which a user may provide 1) an input text having an original reading level, and 2) a selection of a selected target reading level, out of a plurality of target reading levels, for converting the input text;
   program code for determining or estimation the original reading level of the input text;
   program code for holding data relating to the reading level of a plurality of archived texts;
   program code for simplifying the input text on the basis of the selected target reading level;
   program code for communicating with the reading level database to obtain data relating to a reading level classification of words from the plurality of archived texts; and
   program code for preparing and outputting a simplified text of a less difficult reading level that the input text that substantially preserves the meaning of the input text.
2. A computer program product for use on a computer system for simplifying text, the computer program product comprising a tangible, non-transient computer usable medium having computer readable program code thereon, the computer readable program code comprising:
   program code for receiving the input text from a user interface; program code for generating an estimated reading level, from of a plurality of reading levels, for the input text;
   program code for generating a simplified version of the input text, based on a reading level that is less difficult than the estimated reading level, in a manner that preserves a meaning of the input text in the simplified version; and program code for outputting the simplified version to the user interface.
3. A computer-implemented method for simplifying an input text, the method comprising:
   receiving a document in the form of a sequence of vectors where each vector represents a word;
   generating an estimated reading level, from of a plurality of reading levels, for the document; and
   outputting a sequence of vectors obtained by a predication of a neural network that represent a simplified version of the document, based on a reading level that is less difficult than the estimated reading level, in a manner that preserves a meaning of the input text in the simplified version.
4. The computer implemented method of the network in innovation 3 that comprises an encoder-decoder network where the learnt code can be decoded to the desired target reading level.
5. The computer implemented method of innovations 3, wherein the neural network parses the input and recognizes the syntax and then uses the syntactic relations to encode words from the input as vectors.

What is claimed is:

1. A system for classifying a reading level of an input text, the system comprising:
an interface configured to receive 1) an input text having an original reading level, and 2) a selection of a selected target reading level, out of a plurality of target reading levels, for converting the input text;
a reading level estimation engine configured to determine or estimate the original reading level of the input text;
a reading level database configured to hold data relating to the reading level of a plurality of archived texts;
a text simplification engine configured to:
simplify the input text on the basis of the selected target reading level,
communicate with the reading level database to obtain the data relating to a reading level classification of words from the plurality of archived texts, the text simplification engine being trained to simplify text using the training data, and
to prepare and output a simplified text of a less difficult reading level that substantially preserves the meaning of the input text.

2. The system as defined by claim 1, wherein the text simplification engine uses the frequency of a particular word and/or phrase having the target reading level in the reading level database to simplify texts.

3. The system as defined by claim 1, further comprising a parsing module configured to parse the input text into its grammatical constituents.

4. The system as defined by claim 1, further comprising a topic modeling module configured to analyze the input text to determine the topic of its content.

5. The system as defined by claim 1, further comprising a sentence splitting module configured to split, delete, and reorganize sentences from the input text in order to simplify the text.

6. The system as defined by claim 1, wherein the text simplification engine is configured to output a plurality of simplified text options.

7. The system as defined by claim 6, wherein the text simplification engine is configured to receive a selection and/or a modification of at least one of the plurality of simplified text options, and to use the selection and/or the modification as feedback to update the reading level database so as to improve the quality of future simplified texts.

8. The system as defined by claim 1, wherein the text simplification engine substitutes words and/or phrases at the original reading level with words and/or phrases having a higher probability of being in the target reading level.

9. A computer database system comprising:
an archive of words in texts, each of the texts having been assigned a reading level out of a plurality of reading levels, wherein a plurality of the individual words and/or phrases in a respective text receives an assigned reading level corresponding to the respective text;
the database configured to calculate a probability level indicative of a probability that a particular word and/or phrase is in a particular reading level on the basis of the plurality of assigned reading levels of the particular word and/or phrase;
the database further configured to communicate with a convolutional neural network to determine or estimate the reading level of an inputted text on the basis of at least the frequency and probability level of words and/or phrases in the inputted text.

10. The computer database of claim 9, wherein the neural network is configured to; 1) output a simplified text option at a target reading level, and 2) to receive feedback on the simplified text option from a user, and
the database is configured to modify the probability level of a word and/or phrase in the simplified text option on the basis of the feedback.

11. The computer database of claim 10, wherein the feedback is a selection and/or modification of the simplified text option

12. A computer-implemented method for simplifying an input text, the method comprising:
receiving an input text;
generating an estimated reading level, from of a plurality of reading levels, for the input text;
generating a simplified version of the input text, based on a reading level that is less difficult than the estimated reading level, in a manner that preserves a meaning of the input text in the simplified version; and
outputting the simplified version to a user interface.

13. The computer-implemented method of claim 12 wherein a plurality of simplified versions are output to the user interface.

14. The computer-implemented method of claim 13 further comprising prompting a user to make a selection of a preferred simplified version from the plurality of simplified versions.

15. The computer-implemented method of claim 14 further comprising using the selection of the preferred simplified version in a feedback loop to affect the output of future simplified versions.

16. The computer-implemented method of claim 1 wherein generating the estimate of the reading level of the input text comprises quantifying the difficulty of the input text by using a convolutional neural network.

17. The computer-implemented method of claim 1 wherein the input text is received from a web-browser and is output in the web-browser.

18. The computer-implemented method of claim 1 wherein the text is an entirety of a document.

19. The computer-implemented method of claim 1 wherein generating a simplified version of the text comprises determining splitting a sentence from the input text into simpler portions.

20. The computer-implemented method of claim 1 wherein generating the estimated reading level of the input text comprises:
accessing a database having an assigned reading level for a plurality of texts, wherein substantially all of the words in each of the texts are assigned the reading level of their respective text;
generating a word difficulty level based on the frequency that a selected word is assigned a selected reading level; and
using the word difficulty level of the words in the input text to generate the estimated reading level of the input text.

21. The computer-implemented method of claim 1 wherein the input is configured to receive the input text from the user interface or an application programming interface.
